(19) United States
(12) Patent Application Publication
(10) Pub. No.: US 2006/0239604 A1
(43) Pub. Date: Oct. 26, 2006

(54) High Average Power High Efficiency Broadband All-Optical Fiber Wavelength Converter

(75) Inventors: Michael E. Marhic, San Francisco, CA (US); Glen M. Williams, Alexandria, VA (US); Lew Goldberg, Fairfax, VA (US); Jean-Marc P. Delavaux, Pittstown, NJ (US)

Correspondence Address: MICHAEL MARHIC, 1155 JONES ST., # 503, SAN FRANCISCO, CA, 94109, US

(73) Assignees: OPAL LABORATORIES, San Francisco, CA (US); KEOPSYS, INC., Pittstown, NJ (US)

(21) Appl. No.: 11/307,929

(22) Filed: Feb. 28, 2006

Related U.S. Application Data
(60) Provisional application No. 60/593,982, filed on Mar. 1, 2005.

(51) Int. Cl. G02B 6/00

(52) U.S. Cl. 385/13

(57) ABSTRACT

We introduce a novel high average power (>100 mW) fiber optic source, using a wavelength converter based on optical parametric amplification in a nonlinear fiber. In the most fundamental embodiment, light at two different wavelengths is used to generate light at a third wavelength through optical parametric amplification in a highly non-linear fiber. The method provides high average output power at wavelengths that are not accessible by other means. The source has high optical conversion efficiency (>20%), and it can be tuned over tens of nanometers.

### I. SUMMARY OF INVENTION

We describe a method for constructing an optical wavelength converter. The wavelength converter uses optical parametric amplification in an optical waveguide to convert input wavelengths, lambda₁ and lambda₃ into a third wavelength,
lambda₄=1/(2/lambda₁−1/lambda₃)

The converter we will describe has the following unique attributes:

1) High conversion efficiency, i.e. exceeding 10%;

2) Wide tuning range, i.e. output power within 1 dB of its maximum value over at least 30 nm;

3) High average output power, i.e. in excess of 100 mW;

4) All optical waveguide construction for robustness and compactness.

This regime of operation is new. As the following will show, its existence is far from being obvious, even to anyone skilled in the art. This invention therefore teaches for the first time how to make fiber-based WCs with the aforementioned attributes, which should be useful in many practical applications.

### II. STATE OF THE ART

Here we review the state of the art.

II.A. Conventional Source Wavelength Limitations.

To date some of the most important laser systems are based on rare-earth ions (erbium, neodymium, ytterbium, thulium, praesodymium) used as dopants in silica glass, or in some crystals. While these dopants can form the basis for powerful and efficient lasers in certain wavelength ranges, the emission spectrum of each dopant is limited. FIG. 1 shows the wavelength ranges covered by the main ions in fiber lasers. It can be seen that there are gaps between the emission spectra. For applications that require a specific wavelength, this can be a problem if that wavelength falls in one of the gaps.

As an illustration, let us consider the 1620-1700 nm spectral region. It is important as it contains numerous molecular resonance lines of chemical species (i.e. Ammonia, Methane, Ethane, and Ethylene). Unfortunately, it falls between spectral regions where efficient rare-earth-doped fiber amplifiers can generate large amounts of tunable power. Hence, if novel efficient sources of radiation could be developed in that region, they could be used for a variety of applications such as remote sensing, lidar, etc. In addition, since such sources would be eye-safe, they could also be considered for free-space communication, target designation, identification friend-or-foe, etc. For these reasons, efforts have been made to develop such sources. A Q-switched Er:YAG laser producing 7 W of average power at 1645 nm was recently reported [2]; however, since it is not tunable its use for remote sensing is limited.

II.B. Wavelength Converters.

Nonlinear optics phenomena can be used to convert the output of a laser to a new wavelength range. Such a device is known as a wavelength converter (WC). WCs form a very important class of devices, as they can in principle be used for converting the radiation of existing lasers to wavelengths in under-served regions of the electromagnetic spectrum.

Wavelength conversion by nonlinear effects can take place in short nonlinear crystals; in that case the second-order susceptibility chi⁽²⁾ is exploited. It can also take place in optical fibers, in which case the nonlinear effects are associated with the third-order susceptibility chi⁽³⁾. The nonlinear interactions in fibers are enhanced by: (i) the high-power density achievable in a fiber because of its small core diameter; (ii) the long interaction lengths available in low-loss fibers.

II.B.1. Crystal-based WCs have been in development for several decades. Periodically-poled lithium niobate (PPLN) has emerged as a very important nonlinear crystalline medium. PPLN has been used in a wide variety of nonlinear optics demonstrations. In particular wavelength conversion based on optical parametric oscillators (OPOs) has obtained impressive results. For example, Sandia National Laboratories developed an OPO pumped by a 10 W Ytterbium-doped fiber laser (YDFL) to generate several hundred milliwatts at 3.5 microns, with a conversion efficiency of several percent. I. D. Linsay of the University of Twente recently reported a similar WC, generating 1 W of power at 3.5 microns when pumped by 6.9 W at 1.08 microns; the optical conversion efficiency was 15%, which is substantial.

These devices suffer from several drawbacks, namely; (i) it is difficult to couple the output into a single-mode optical fiber for flexible delivery; (ii) the PPLN-crystal-based OPO cavity may be affected by environmental factors such as vibrations, dust, etc. These aspects may limit the usefulness of such WCs in many industrial or military applications.

At the same time we note that these devices do use high-power fiber amplifiers for supplying the pump. This leads to the idea that if the WC could be fabricated entirely from fiber devices, it would not be subject to the above limitations, and might thus be better suited for some applications.

II.B.2. Fiber-based WCs have received far less attention than their crystal-based counterparts, particularly when it comes to high-power conditions (which we define as using a pump power in excess of 1 W).

To date fiber-based WCs have been primarily investigated for wavelength conversion in optical communication systems. In that case it is generally desirable to convert a group of wavelengths at the same time. Also, in order to preserve signal quality, it is necessary to operate in the region of linear gain (gain independent on power level), and therefore to avoid depleting the power of the pump.

By contrast, in many other areas of applications, it is desirable to convert only a single wavelength, and to maximize its output power. This in turn implies that the pump should be strongly depleted. This regime is very different from that encountered in communications, and therefore it must be explored in great detail to identify operating conditions leading to desirable attributes for the converted output power.

To our knowledge, only a few experiments on high-power one-pump fiber-based WCs have been reported to date:

(i) A CW fiber-based wavelength converter, using four-wave mixing (FWM) and Raman gain in a 9-km long dispersion-shifted fiber (DSF), generated 371 mW of power at 1664.7 nm [3]; however, its fixed wavelength and large linewidth (1.7 nm) restrict its practical use.

(ii) A different approach, based on a one-pump fiber optical parametric amplifier (OPA) demonstrated 92% pump depletion in an 11-km DSF [4].

(iii) In Ref. [5], at least 88% pump depletion was obtained in a two-pump fiber OPA with fixed pump wavelengths, as the signal wavelength was tuned over a 25 nm range. The latter work provided the first demonstration of the ability of fiber OPAs to provide broad uniform conversion spectra in the regime of strong pump depletion. This work, however, cannot be used for designing one-pump fiber OPAs, as the characteristics of two-pump OPAs are quite different.

II.C. US Patents

U.S. Pat. No. 6,606,187 concerns the use of fiber optical parametric amplifiers for telecommunication applications, in conjunction with cascaded Raman amplifiers. The regime of operation is completely different from the one considered in the present application. In particular, the idler is not used for wavelength conversion, and the output powers contemplated are low (less than 100 mW), as is suitable for communication signals. Hence there is essentially nothing in that patent that can be used for inferring how a fiber OPA can be used in the manner proposed in the present application.

U.S. Pat. No. 6,301,273 deals with frequency conversion from the near IR to the mid-IR (defined in claim 6 as ranging from 2 microns to 5 microns). This region is beyond what is contemplated in the present application. Also, the nonlinear means for obtaining the new wavelength is not an optical fiber using the third-order nonlinearity, but rather a nonlinear crystal using the second-order nonlinearity. Although this is not explicitly stated in claim 1, it is made abundantly clear throughout all the subsequent claims, as well as in the text of the specification. Indeed, this is the only way that the mid-IR can be reached by starting from the near-IR. Therefore, this patent does not deal with a fiber optical parametric amplifier, and cannot be used to infer how to perform the type of wavelength conversion described in the present application.

U.S. Pat. No. 6,647,193 describes how to make a nonlinear fiber suitable for exhibiting a zero-dispersion wavelength near 1490 nm, i.e. in the S-band. It provides no other information that could be useful for designing a broadband high-efficiency wavelength converter, either in the S-band, or elsewhere.

### III. DETAILED DESCRIPTION

In the fiber OPA a pump at the radian frequency w₁ and a signal at w₃ interact to generate a new wave, the idler, at the frequency w₄=2 w₁−w₃. (Radian frequency w is related to wavelength lambda by w=2 pi c/lambda, where c is the speed of light). The frequency relation shows that signal and idler are located symmetrically about the pump.

Efficient idler generation can be obtained if phase matching is satisfied; this requires that w₁−w₀, the fiber zero-dispersion frequency. w₄ can then be tuned by tuning w₃. Generally, only pump and signal are present at the input, and all three waves are present at the output.

This is illustrated schematically in FIG. 2, which shows typical input and output spectra of an OPA. The signal input power is 1 W and the pump input power 3 W, for a total input power of 4 W. At the output the total power is still 4 W. The pump power has dropped to 0 W, and the pump is said to be fully depleted. The signal and the idler have each gained one half of the original pump power. Therefore, the signal output power is 2.5 W, and the idler output power is 1.5 W. Thus we see that this device has created a powerful new wave, the idler, with an optical conversion efficiency (idler power divided by total input power) of 37.5%.

It is important to note that while m in the example of FIG. 2 is smaller than w₁, we could just as easily have w₃>w₁, in which case the idler would have a smaller frequency than the pump. Therefore, fiber OPAs can be used just as easily for converting the power of two initial frequencies to a third one, which can be either lower or higher than the initial frequencies.

In the following we are going to show that an example such as in FIG. 2 is actually realistic. We first present the theoretical framework for establishing a unique design for an all-fiber WC that will have: high output power, high optical conversion efficiency, and broadly tunable output.

III.A. Theoretical Framework for WC Design

The basic assumptions and the notations are the same as in Refs. [4] and [6]. As explained in Ref. [4], if only pump and signal power are present at the input, the idler output power P₄ is obtained in terms of the roots of the polynomial equation in x
h(x)=(P₁₀−2x)²(P₃₀+x)x−(1/4)[−(Db/g+DP₀)x+3x²]²=0 (1)

where: P₁₀ is the input pump power; P₃₀ is the input signal power; DP₀=2P₁₀−P₃₀; Db is the wavevector mismatch; g is the fiber nonlinearity coefficient.

Listed in increasing order, the roots of Eq.(1) are {eta₁, eta₂, eta₃, eta₄}. Here x=0 is a root of h(x)=0, which can be shown to be eta₂. As a function of distance z along the fiber, P₄ oscillates between the two smallest positive roots, hence between 0 and eta₃. The equation h(x)/x=0 is a third-order polynomial equation, and therefore its three roots

{eta₁, eta₃, eta₄} can be written explicitly in terms of elementary functions by using Cardano's formula [7]. Then using the expression for P₄ in terms of a Jacobian elliptic function [8], we can write an expresion for P₄ showing explicitly its dependence on all the parameters. This allows us to plot variations of P₄ versus idler wavelength, and hence to obtain accurate plots of conversion spectra.

We have also developed a simplified approach, which has the merit of showing in a transparent manner: (i) under what circumstances complete pump depletion can be achieved, and (ii) how nearly-complete pump depletion can be obtained over large bandwidths, leading to flat broadband conversion spectra.

III.A.1. Conditions for Complete Pump Depletion

The frequency relation 2w₁=w₃+w₄ indicates that when the pump releases a pair of photons both signal and idler each gain one photon. Thus, if the pump is completely depleted, both signal and idler powers have increased by P₁₀/2. For the idler power, this must be its maximum value, which is also eta₃; so we must have eta₃=P₁₀/2. Substituting into Eq.(1), we find that we must have Db=Db_{NL}, where
Db_{NL}=g(P₃₀−P₁₀/2) (2)

is a constant which can be interpreted as a nonlinear wavevector mismatch. (Note that this condition is more general than that in Ref.[4] where we assumed that P₃₀<<P₁₀) We also see that P₁₀/2 is actually a double root, i.e. that eta₃=eta₄=P₁₀/2. This leads to k=1, which in turn implies that the function sn reduces to a tanh, which is a non-periodic function [4]. Hence in principle one needs an infinitely long fiber to actually obtain complete pump depletion. In practice, however, nearly-complete pump depletion can be obtained after a length of the order of In(P₁₀/P₃₀)/gP₁₀.

III.A.2. Obtaining Nearly-Complete Pump Depletion Over a Large Bandwidth

We will begin with a qualitative discussion of the conditions necessary to obtain large pump depletion over a large bandwidth. We will then follow with an accurate study of the conversion gain spectra, by means of the analytic solution.

III.A.2.1. Qualitative Description of the Conversion Gain Spectra

Writing Db as in Ref. [6], we have
Db=beta2(Dwₛ)²+beta4(Dwₛ)⁴/12 (3)

where: bₘ denotes the mth derivative of the propagation constant b(w) with respect to w, evaluated at the pump frequency; Dwₛ=w₃−w₁. According to Eq.(2), complete pump depletion can be obtained when Db=Db_{LN}. This can be viewed as a second-order polynomial equation for the quantity u=(Dwₛ)². This equation can have 0, 1, or 2 real roots for u that are positive or equal to zero, depending on the values of the parameters entering the equation. We denote these roots by u₁ and u₂ (u₁<u₂) when there are two, and by u₁ when there is only one.

Intuitively, to obtain near-complete pump depletion over a wide bandwidth, it appears necessary that Db should remain close to Db_{NL} over a wide frequency region. And to do so it will probably be helpful to have Db cross Db_{NL} once or twice within that region. This is very similar to the analysis that was performed in Ref. [6], where we studied the shape of Db in relation to −gP₁₀ (optimum value for achieving maximum small-signal gain). So here we will perform an analogous study, but this time we will study Db in relation to Db_{NL}, its optimum value for complete pump depletion.

We assume that the fiber is chosen, so that g and beta₄ are fixed (we also assume that beta₄<0, which has been the case for all fibers used in OPA work in recent years; if one had beta₄>0 the analysis would need to be appropriately modified). However beta₂ can be varied at will in sign and magnitude by adjusting lambda₁ around lambda₀, the fiber zero-dispersion wavelength. The graphs of Db versus u are parabolas passing through the origin of the axes, where their slopes are equal to beta₂. They may or may not intersect horizontal lines drawn at Db_{NL}, depending on the parameters. Let us consider some important cases, illustrated in FIG. 3.

(i) Db_{NL}=0.

In that case the horizontal line is the horizontal axis itself. Since any parabola intersects that axis at the origin, Eq.(3) has a root at u₁=0, and complete pump depletion will always be achievable there.

If beta₂=0 the parabola remains close to the horizontal axis for a long distance before diverging from it. Hence we expect that this case will lead to a rather flat gain spectrum, decreasing very gradually from its maximum.

To obtain another interesting intersection, at u₂>0, we need to choose beta₂>0. The larger beta₂, the larger u₂ will be, but also the faster the parabola will depart from the horizontal axis near the origin. The result is that the wider the spectrum will be, the more ripple it will have. This represents a design tradeoff.

We mention the case beta₂<0 for completeness. In that case there is only one intersection at the origin. The more negative beta₂ becomes, and the faster the parabola diverges from the horizontal axis, which leads to a narrower gain spectrum. Thus this regime is not useful for maximizing spectrum bandwidth.

(ii) Db_{NL}>0.

The horizontal line is now above the horizontal axis. The origin is no longer on that line, for any parabola, and is thus no longer suitable for complete pump depletion.

There is always a particular positive value of beta₂ for which the parabola is tangent to the line. In this case, we will have a u₁ away from u=0. As Db_{NL} increases, u₁ increases and the bandwidth around it decreases.

For larger beta₂, there will be two intersection points, at u₁ and u₂. As beta₂ increases u₁ and u₂ will move apart, but so will the maximum value of Db−Db_{NL}. Hence there will again be a tradeoff between gain bandwidth and gain ripple.

If beta₂ is too small, there will be no intersection, and no opportunity to obtain an interesting spectrum.

The regime Db_{NL}>0 can thus lead to interesting gain spectra, provided that Db_{NL} is not too large.

(iii) Db_{NL}<0.

In that case there will always be a single intersection with a parabola, at u₂>0. For small −Db_{NL} the conversion gain spectrum may be wide and fairly flat, but for large −Db_{NL} it will exhibit a single narrow peak away from u=0.

In summary, our investigation of the shape of Db in relation to Db_{NL} has revealed that the best opportunities for obtaining a wide conversion gain spectrum with low ripple is to operate in a regime where Db_{NL}=0, or P₃₀=P₁₀/2 (approximately).

III.A.2.2. Accurate Description of the Gain Spectra using the Analytic Solution

As discussed in Section III.A., g(x)=h(x)/x is a third-order polynomial. It can be written in the form g(x)=ax³+bx²+cx+d, where
a=7/4; b=(5/2)P₃₀−P₁₀+(3/2)(Db/g); c=P₁₀²−4 P₁₀P₃₀−(1/4)(Db/g+2P₁₀−P₃₀)²; d=P₃₀P₁₀².

Letting b′=b/a, c′=c/a, d′=d/a, and y=x+w=x−b′/3, we obtain
g(x)=l(y)=a(y³+3py−2q), (5)

where
p=(3 w²+2 b′w+c′)/3 and q=−(w³+b′w²+c′w+d′)/2 (6)

The three roots of l(y)=0, y₁, y₂, y₃, are then given by Cardano's formula. The three roots of g(x)=0 are given by x₁=y₁−b′/3, x₂=y₂−b′/3, x₃=y₃−b′/3. Finally, {eta₁, eta₃, eta₄} is obtained by listing x₁, x₂, x₃ in increasing order.

Some remarks are of interest:

1) Two of the roots (eta₃ and eta₄) coincide when p³+q²=0. It can be shown mathematically that this corresponds to Db=Db_{NL}, i.e. to Db being suitable for maximum pump depletion. This makes physical sense, because when eta₃=eta₄, eta₃ reaches its maximum value, which must correspond to maximum pump depletion.

2) When the OPA is well optimized for gain flatness, the sn function is very close to 1, and therefore we have approximately P₄=eta₃. This can be a very useful approximation, because the calculation of eta₃ involves only elementary functions, and avoids the calculation of sn altogether.

III.A.2.3. Optimizing Fiber Length and Signal Power

While obtaining complete pump depletion appears to be a desirable goal for a WC, there are several reasons why one should not necessarily strive to come as close to it as possible. They are:

(i) Fiber length. Complete pump depletion in principle requires that the fiber length be infinite, which is physically impossible. Clearly one can come very close to it by using a very long fiber. Using a very long fiber, however, would introduce several problems, namely:

Increased cost

Background fiber loss. After some length any increase in idler output will be counter-balanced by background fiber loss.

Low SBS threshold. If L is much greater than the nonlinear length L_{NL}=1/gP₁₀ SBS suppression becomes problematic if a narrow linewidth output is desired.

Large dispersion fluctuations. In very long fibers, one can have very significant dispersion variations along the fiber. The presence of such fluctuations makes the WC performance depart from that expected from a uniform fiber, and difficult to predict. On the contrary, if one can use a very short fiber, dispersion fluctuations can become negligible, and OPA performance can then be reliably predicted based on simple models assuming constant dispersion (presented here).

(ii) Conversion efficiency. Conversion efficiency is the ratio of desired output power and input power. For a WC the idler output power P₁=P₄ is clearly the desired output power. Several definitions of input power are possible: electrical power supplied by the wall plug; optical power supplied by the multimode LDs pumping the EDFAs; OPA pump power P₁₀; etc. Here we define the input power as the total optical power entering the OPA; therefore, we have the following definition of conversion efficiency
eta_{eff}=P₄/(P₁₀+P₃₀) (8)

This is a realistic definition of the intrinsic conversion efficiency of the OPA itself, as it includes all the input power, and not just the pump power. It is a quantity that one would wish to maximize when designing an OPA-based WC.

In view of (i) and (ii), it is now clear that designing a WC to approach complete pump depletion is not a very desirable strategy, because that would require a very long fiber with all its associated problems. A better approach is to design it so that it will exhibit a large conversion efficiency eta_{eff}, over a large tuning range Dlambda, using a small fiber length L, by suitable choice of the signal power P₃₀. Such design will involve a tradeoff between all three goals, and the choice of an optimum design will be possible only by introducing some priorities or rules for choosing a design that represents the best compromise between the three features.

Here we examine in detail the tradeoffs between eta_{eff}, L, P₃₀, and Dlambda.

eta_{eff} vs L. We have shown that it is possible to obtain flat conversion gain spectra when Eq.(2) has two positive roots. In that case, eta_{eff} across the tuning range will be about the same as it is at the location of the roots. If there is only one root, eta_{eff} will peak at the location of that root. At these points we have {eta₁, eta₃, eta₄}={−16/7 P₃₀, P₁₀/2, P₁₀/2} and sn becomes a tanh. We can then write eta_{eff} explicitly as follows

eta_{eff} vs P₃₀. An important point is that the highest eta_{eff}'s are obtained for the lowest values of P₃₀. However, one needs a larger L to come close to these eta_{eff}'s. Actually, we note that the plots for two different values of P₃₀ cross at some value of L, L_{c}. For L<L_{c}, eta_{eff} for the larger P₃₀ is larger, and this is reversed for L>L_{c}. This shows that for a fixed L, increasing P₃₀ may actually lead to a decrease in eta_{eff}. It can be shown that this occurs even though here P₄ always increases with P₃₀. The decrease of eta_{eff} for increasing P₃₀ can be traced to the definition of eta_{eff} by Eq.(8): if P₄ increases, but (P₁₀+P₃₀) increases faster, then eta_{eff} decreases.

Dlambda vs L. Let us now consider how Dlambda varies as L is reduced. From the preceding, we expect that the maximum eta_{eff} in the tuning range will be reduced. In addition, since a smaller L also implies smaller nonlinear phase shifts, we can anticipate that across the tuning range P₄ will be more uniform, and that Dlambda itself will be larger. This provides a design tradeoff.

III.A.4. Numerical Examples

To illustrate the theoretical considerations presented above, we now present results of simulations carried out by using the exact solution, for designs guided by our qualitative observations. sn was calculated by its power series expansion, truncated after 10 terms; the complete elliptic integrals K and K′ required to calculate sn were obtained by numerical integration over 1000 intervals [8].

III.A.4.1. WC with P₁₀=3 W.

We first consider an example with a pump power P₁₀=3 W. This is larger than has been used previously in telecommunication-related work, and even pump depletion experiments [4]. On the other hand, this is still quite small compared to the output of some fiber lasers [1]. Experiments with such pump powers are feasible today, and we will present experimental results under such conditions in Section IV.

In the following we assume that a highly-nonlinear fiber (HNLF) is used, with the following parameters: g=12 W⁻¹ km⁻¹; lambda₀=1612 nm; beta₄=−1*10⁻⁵⁵ s⁴ m⁻¹; dispersion slope=Dlambda=0.024 ps nm⁻² km⁻¹. The parameters which can be varied are L, P₃₀, and lambda₁.

III.A.4.1.1. Conversion Gain Spectra for Different Values of P₃₀ and L.

FIG. 4 shows a set of gain plots obtained by assuming that lambda₁=1611.8 nm, L=80 m, and varying P₃₀ from 0.4 W to 1.6 W. We note that P₄ never exceeds 1.5 W, as it should. As expected from section 2, for P₃₀<<1.5 W, we have a spectrum with a single narrow peak far from the origin. For P₃₀=1.6 W we obtain a flat spectrum which is quite wide. The spectra for P₃₀=1.2 W or 1.6 W appear to provide good combinations of large tuning range, and small deviation from the maximum over the tuning range.

FIG. 5 is the same as FIG. 4, except that L=40 m. The shapes of the curves are similar, except that the idler power levels are lower, and the tuning ranges are larger. This is in agreement with the discussion of section III.A.2.3., examining tradeoffs between L, Dlambda, and eta_{eff}.

III.A.4.1.2. Conversion Spectra for Different Values of Lambda₁

FIG. 6 shows a set of gain plots obtained by assuming that P₃₀=1.8 W, lambda₁=1612 nm, and varying lambda₁ from 1611.6 to 1612.2 nm. For lambda₁=1612 nm, we have a spectrum with a maximum at lambda₄=1612 nm, and decreasing monotonically; it is not as wide as the widest monotonically decreasing spectrum of FIG. 4. For lambda₁=1612.2 nm, the spectrum has a similar shape, but drops even faster. For lambda₁=1611.8 nm the gain spectrum has a single maximum near lambda₄=1637 nm, and it is quite flat. Finally, for lambda₁=1611.6 nm we obtain the widest gain spectrum; it has two maxima.

III.A.4.1.3. Conversion Efficiency vs L

FIG. 7 shows plots of eta_{eff} vs L, for different values of P₃₀. Since these curves increase monotonically with L, in all cases longer fibers lead to increased eta_{eff}. However, since the rate of increase decreases for large L, after a certain point one obtains diminishing returns by further increasing L. Also note that any effect of fiber background loss is not included in these calculations.

III.A.4.1.4. Conversion Efficiency vs P₃₀

FIG. 8 shows plots of eta_{eff} vs P₃₀, for different values of L. As noted in section III.A.4.4., for each value of L, the plot passes through a maximum at a particular value of P₃₀. If it is important to maximize eta_{eff}, then this value of P₃₀ should be considered to be the optimum.

(Note that the existence of the curves of FIG. 7 and FIG. 8 requires one or two positive solutions for Eq. (2); from section III.A.2.1. we know that this can always be satisfied by suitable adjustment of beta₂; we do not consider the impact that this has on tuning range, conversion efficiency ripple, etc.).

III.A.4.2. WC with P₁₀=300 W

Let us now consider a WC using a pump power of 300 W. Since singlemode fiber lasers can deliver CW powers in excess of 1 kW, it is probable that in the future there will be interest in exploring the possibility of using such sources for wavelength conversion, to create powerful sources of radiation in spectral regions not served by fiber lasers themselves.

The pump power is 100 times larger than in the preceding example, and we can use the considerations of Section III.A.3. to see how the WC output would scale compared to the 3 W-pump case. The simplest consideration is that if we also increase the signal input power by 100, to about 150 W, we will obtain a very flat conversion spectrum, with idler power of the order of 150 W. This is true regardless of the type of fiber used.

The bandwidth, however, depends on the fiber. If we use the same HNLF as in section III.A.4.1., then g and beta₄ are the same, and so the bandwidth scales like (P₁₀)^{1/4}. It is therefore larger by (100)^{1/4}=3.16, or about 300 nm. This is considerable, and could be attractive for some applications.

The fiber would have to be about 100 times shorter than before, or just 80 cm long. However, given the same background loss as before, this fiber would have to dissipate the same power as the preceding one, in 1/100 of the length. Thus the power to be dissipated per unit length would be 100 times larger than in the first example.

To improve the heat dissipation situation, we could consider using a fiber like DSF, with a g which is about 1/10 that of DSF. This will increase the required length to 8 m, and thus reduce the heat load per unit length by the same factor. Also the core size will be larger, which may help to withstand the power.

On the other hand, DSF has a beta₄ which is about 10 times as large as HNLF. Since the bandwidth scales like (gP₁₀/beta₄)^{1/4}, we see that the 300-W-pump WC made from DSF would have exactly the same bandwidth as the 3-W-pump WC made from HNLF.

Finally, we could also consider the possibility of using a large-core fiber, as is commonly used in fiber lasers with kW output power [1]. Since such fibers have g much smaller than DSF, the required length would be much longer than 8 m, possibly up to 80 m, which would be similar to the fiber lengths used for the fiber lasers themselves, which are known to handle such high powers. On the other hand the reduced g will reduce the bandwidth. Since for such fibers beta₄ is not well known, it is not possible to predict what the actual bandwidth would be.

III.A.5. Discussion

It is interesting to note that while one-pump OPAs cannot provide very flat gain spectra in the case where the pump is undepleted [6], while two-pump OPAs can [5], we have shown here that one-pump OPAs can provide very flat gain spectra when the pump is strongly depleted. Thus two-pump OPAs do not have an obvious advantage over one-pump OPAs as far as providing flat gain in the case of strong pump depletion. This shows that the opposite statement made in Ref. [5], based on extrapolation from the undepleted-pump regime, is not valid under all circumstances.

When the pump is completely depleted, 50% of its input power is converted into idler output power, so the pump-to-idler conversion efficiency is 50%. This sounds impressive, but unfortunately it does not tell the whole story, since the signal input power is not taken into account. We were therefore led to define a more useful measure of conversion efficiency, namely the ratio of the desired idler output power to the total input power. Since P₄ can approach P₁₀/2, we see that eta_{eff} can approach 50% when P₃₀<<P₁₀, but that it will be significantly smaller than 50% if P₃₀ is of the same order as P₁₀. In the preceding we have seen that P₃₀ should be close to P₁₀/2 in order to obtain a flat gain spectrum; in that case eta_{eff} will be close to 33%. Therefore the design of OPA WCs with flat gain spectra involves a tradeoff: increasing the gain bandwidth is accompanied by a drop in the overall conversion efficiency.

III.A.6. Summary of Section III

In this section we set out to design wavelength converters based on fiber OPAs, with the following characteristics: 1) High conversion efficiency, i.e. exceeding 10%; 2) Wide tuning range, i.e. idler power within 1 dB of its maximum value over at least 30 nm; 3) High idler power, i.e. in excess of 100 mW

We have established that to do so one needs to have:

1) A fiber with high nonlinearity coefficient g and low fourth-order dispersion coefficient beta₄, to obtain a large tuning range Dlambda.

2) High input pump power P₁₀, at least twice as large as the desired idler power. This is because at best 50% of the pump photons can be converter to idler photons.

3) Signal input power P₃₀ of the order of half the input pump power P₁₀. This is because the flattest conversion gain spectra can be obtained for P₃₀=P₁₀/2.

4) Pump wavelength lambda₁ tuned near the fiber zero-dispersion wavelength lambda₀, to optimize tuning range Dlambda and conversion gain ripple.

5) Fiber length L chosen to achieve a suitable compromise between conversion efficiency eta_{eff}, and tuning range Dlambda and flatness.

This invention teaches that by following these design rules, wavelength converters with the desired attributes can be designed. The family of wavelength converters based on these rules is novel, and not obvious to anyone skilled in the art. The design rules arrived at here form the basis for the claims presented at the end of this document.

III.B. Example Design

The example we describe is parametric generation of approximately 1 W of CW light in the wavelength region 1620 to 1700 nm using a highly non-linear fiber (HNLF). The design has a signal master oscillator power amplifier (MOPA) and a pump MOPA. For both MOPA's in this example we use Erbium/Ytterbium (E/Y) power amplifers.

The signal master oscillator can be a single wavelength source or a tunable single wavelength source. In addition, it is also possible for the signal master oscillator source to be a multi-wavelength source or a broadband amplified stimulated emission (ASE) source. The signal source has a wavelength range of 1530-1620 nm. This is the practical gain bandwidth of the E/Y amplifier. In practice it may difficult to achieve this full bandwidth performance in a specific E/Y amplifier design. The output of the signal source may be continuous wave (CW) or pulsed. The E/Y power amplifier will approximately maintain the temporal characteristic of the seed if it is designed correctly. It may be necessary to keep the linewidth of the signal source larger than some minimum value, in order to prevent stimulated Brillouin scattering (SBS) in the highly nonlinear fiber (HNLF) used as the parametric amplifier. The issues with SBS will be discussed below in greater detail. The output polarization state of the signal MOPA is preferably linear (requiring a linearly polarized master oscillator output and preferably a polarization maintaining amplifier), but can also be random. However, a random polarization state will result in a reduction in conversion efficiency between pump power and idler power in the parametric amplifier.

In our example design the pump master oscillator is primarily a single wavelength source. This wavelength needs to be near the zero dispersion wavelength (ZDW) of the highly HNLF used in the parametric amplifier, in order to maximize the idler output power and tuning range. It is best to have some limited tunability (±a few nanometers) in the pump source because of: (1) variations in the ZDW along the length of the HNLF as manufactured, (2) requirement to detune the pump wavelength slightly from the ZDW for maximized performance (see section III.A.4.1.2). In our example we have selected the ZDW of the HNLF to be at the long wavelength extreme of the gain bandwidth of the E/Y power amplifier. This allows for the maximum achievable idler tuning (approximately>1620 to 1720 nm) in the wavelength region not accessible in the E/Y bandwidth itself.

Conversely, we could have selected the ZDW to be at the other extreme of E/Y gain bandwidth (1530 nm) allowing idler tuning from approximately 1450 to 1530 nm. In general, this approach could be applied to any laser source with extended tuning. For instance, using Ytterbium doped fiber (Yb) that has a gain bandwidth of approximately 1030 to 1130 nm and HNLF's with appropriate ZDW's we could achieve idler tuning from approximately 945 to 1030 nm and from approximately 1130 to 1250 nm.

As with the signal source, the pump source may be CW or pulsed. However, if both the signal source and the pump source are pulsed care must be taken to ensure the two inputs overlap temporally in the HNLF. SBS is, generally, a more problematic issue for the pump source, owing to its higher power. The issues with SBS will be discussed below in greater detail.

The output polarization state of the pump MOPA is preferably linear (requiring a linearly polarized master oscillator output and preferably a polarization maintaining amplifier), but can also be random. However, a random polarization state will result in a reduction in conversion efficiency between pump power and idler power in the parametric amplifier.

After amplification the signal and pump are combined together in one fiber either using a thin-film based spectral multiplexer or a fused-tapered coupler based spectral multiplexer. The combined signal and pump then enter the HNLF. The HNLF length is selected to optimize idler output power in conjunction with idler tuning bandwidth (as explained in section III.A). In general, the HNLF will be temperature controlled. This permits fine adjustment and/or stabilization of the ZDW (approximately 0.06 nm/C). If both the signal and pump are linearly polarized, efforts should be made to guarantee that the polarizations are aligned as they enter HNLF. This can be accomplished by either using all polarization maintaining components up to launch into the HNLF, or by independently adjusting the polarization states of one or both of the input arms into the multiplexer using polarization controllers such that polarization states match on entry into the HNLF. If the HNLF maintains the relative polarization states through its length the idler generation will be optimized. Maintenance of the relative polarization states in the HNLF is guaranteed if the HNLF is polarization maintaining (PM) by design. However, we have observed, using non-PM HNLF, that idler output power is relatively constant over hours indicating that the relative polarization state of pump and signal is not changing over this time period.

If good conversion is achieved in the HNLF then nearly all the pump power will be equally divided into signal power and idler power. In practice there will be power at signal, pump, and idler wavelengths leaving the HNLF. In some applications it will be best to have light at only the idler wavelength. In order to accomplish this we place a spectral demultiplexer at the output of the HNLF. The spectral demultiplexer may be a thin-film based type or a fused-tapered coupler based type. In its most common application it will separate the signal and pump wavelengths from the idler wavelength, sending only the idler wavelength to the device output. Designing the spectral demultiplexer to send different combinations of signal, pump, and idler to the output is also possible.

III.B.1. Suppression of Stimulated Brillouin Scattering (SBS)

SBS is another nonlinear optical phenomenon encountered in fibers. If a high-power wave, with a small linewidth Deltanu smaller than the Brillouin linewidth (Deltanu_{B}=50 MHz) is passed through a fiber, it may excite sound waves which will in turn strongly reflect the incident power. When this occurs, the incident wave cannot pass through the fiber.

The threshold power for this phenomenon is generally exceeded by the pump powers used in fiber OPAs, and it is therefore necessary to modify some features of the system in order to be able to use it. There are several approaches to doing so. The most common is to broaden the linewidth Deltanu of the incident wave, because when Deltanu>>Deltanu_{B}, the Brillouin gain is reduced by about Deltanu_{B}/Deltanu. Typically, Deltanu must be broadened to several gigahertz to suppress SBS to such an extent that OPA operation is possible. There are mainly two ways to increase Deltanu:

(i) Continuous-wave (CW) operation. In this case one can use phase modulation (PM) or frequency modulation (FM) of the pump. This does not modify the power of the pump wave, which remains constant. Thus the idler output power is itself constant, and we have a CW wavelength converter.

(ii) Pulsed operation. Another approach is to use a pump that is modulated in the time domain, so that it consists of pulses of duration T. Then the pump spectrum has a linewidth Deltanu=1/T(linewidth will be even larger for non-transform limited pulses). Thus, by using short pulses (say nanoseconds-long), one can have Deltanu of the order of several gigahertz, and therefore obtain effective SBS suppression.

It should be noted that since our WC design calls for signal powers which are about half of the pump power, the signal itself can generate SBS. Therefore, the spectrum of the signal must be broadened like that of the pump.

IV. Performance/Demonstration

We performed experiments to verify some of the above predictions. The schematic of the experimental setup is shown in FIG. 10.

The C-band signal is supplied by a DFB laser with nominal wavelength of 1561 nm, which can be tuned over a few nanometers by temperature control. It is amplified to a power of the order of 1 W by C-band amplifier EDFA1. One can also operate the OPA with a signal provided by an external cavity laser, tunable over the entire C-band; in this mode, the idler can be tuned from about 1660 to 1700 nm.

The L-band pump is supplied by a DFB laser with nominal wavelength of 1611 nm. It is amplified to a power of the order of 1 W by the L-band amplifier EDFA2, followed by a narrowband tunable filter TBF to remove ASE produced by EDFA2. EDFA3 then amplifies the pump to a power of up to 3 W.

In order to obtain CW operation it is necessary to suppress stimulated Brillouin scattering (SBS) in the OPA HNLF. To do this, the linewidths of both lasers are increased by modulating their currents by means of the 150-MHz sinusoidal output of the VCOs. This produces some amount of intensity modulation of the DFBs, but more importantly substantial frequency modulation (FM). In this manner it is possible to increase the linewidths to several gigahertz, sufficient to efficiently suppress SBS. The SBS suppression is monitored as the powers are increased, by means of a 1% tap inserted between the WDM coupler and the HNLF (not shown).

The WDM coupler combines signal and pump with low loss into the HNLF. It is of the fused-fiber variety, which can operate reliably at powers as high as 7 W.

The HNLF is manufactured by Sumitomo Electric. It has the following nominal parameters:

lambda₀=1612 nm; g=12 W⁻¹km⁻¹; Dlambda=0.024 ps nm⁻² km⁻¹; beta₄=−1*10⁻⁵⁵ s⁴ m⁻¹; L=40 m.

FIG. 10 shows measured idler output power P₄ as a function of pump power P₁₀, for signal input power P₃₀=0.8 W. The maximum value of P₄=0.9 W was obtained for P₁₀=3 W; this corresponds to an optical conversion efficiency of 23%.

FIG. 11 shows a typical OPA output spectrum displayed by the OSA. The three main peaks correspond to signal, pump, and idler. The two smaller peaks labeled FWM are due to spurious four-wave mixing between the three main waves. They are at least 30 dB lower than the main peaks. This shows that: (i) they have a negligible impact on the optical efficiency; (ii) the three-wave analysis used for the theoretical model is well justified. The ASE level between the main peaks is at least 40 dB lower than the peaks, which shows that the three output waves have a high optical signal-to-noise ratio, which is desirable in some applications.

We also performed experiments with lambda₄ about 20 nm longer, and obtained comparable results.

Discussion. In comparison to the approach described in Ref. [3], our design has several advantages: (i) lambda₄ can in principle be tuned over tens of nanometers with little loss of efficiency, a key consideration in many applications; (ii) our idler linewidth is small (<0.1 nm), which is important for probing resonant lines; (iii) we use a short fiber (40 m vs 9 km), which has cost and packaging implications.

The experimental results presented here are preliminary, and we anticipate that it should be straightforward to make the following improvements: (i) demonstrate wide tunability by using a tunable signal source, and a tunable filter; (ii) increase idler output power and conversion efficiency by scaling signal and pump powers.

### REFERENCES

1. D. N. Payne, et. al., Proceedings of the SPIE, 2005; vol. 5709, no. 1, p. 133-41, Conference: Fiber Lasers II: Technology, Systems, and Applications, 27 Jan. 2005, San Jose, Calif., USA.

2. Y. E. Young, S. D. Setzler, K. J. Snell, P. A. Budni, T. M. Pollak, and E. P. Chicklis, “Efficient 1645-nm Er:YAG laser”, Opt. Lett. 29, 1075-1077 (2004).

3. D. A. Chestnut, C. J. S. De Matos, and J. R. Taylor, “High-Power 1664.7-nm Fiber Source Based on Raman and Parametric Gain,” CLEO 2002, paper CThS3, p. 569 (2002).

4. M. E. Marhic, K.-Y. Wong, M. C. Ho, and L. G. Kazovsky, “92% Pump Depletion in a CW One-Pump Fiber OPA,” Opt. Lett. 26, 620-622 (2001).

5. J. M. Chavez Boggio, P. Dainese, F. Karlsson, and H. L. Fragnito, “Broad-band 88% efficient two-pump fiber optical parametric amplifier,” IEEE Photon. Technol. Lett., 15, 1528-1530 (2003).

6. M. E. Marhic, N. Kagi, T.-K. Chiang, and L. G. Kazovsky, “Broadband Fiber Optical Parametric Amplifiers,” Opt. Lett. 21, 573-575 (1996).

7. B. L. van der Waerden, Algebra, Vol. I (Springer-Verlag, New York, 1991).

8. M. Abramowitz and I. Stegun, eds, Handbook of Mathematical Functions, Vol. 55 of Applied Mathematics Series, National Bureau of Standards, Washington, D.C. (1964).

9. M. E. Marhic, Y. Park, F. S. Yang, and L. G. Kazovsky, “Broadband Fiber Optical Parametric Amplifiers and Wavelength Converters with Low-Ripple Chebyshev Gain Spectra,” Opt. Lett. 21, 1354-1356 (1996).

10. M. E. Marhic, K. K.-Y. Wong, G. Kalogerakis, and L. G. Kazovsky, “Toward Practical Fiber Optical Parametric Amplifiers and Oscillators,” Optics and Photonics News, 15, 20-25 (2004).

11. M. E. Marhic, G. M. Williams, L. Goldberg, and J.-M. P. Delavaux, “Tunable Fiber Optic Parametric Wavelength Converter with 900 mW of CW Output Power at 1665 nm,” Photonics West, San Jose, Calif., Jan. 21-26, 2006.

### FIGURE CAPTIONS

FIG. 1 Spectral coverage of the main rare-earth ions that make efficient fiber amplifiers.

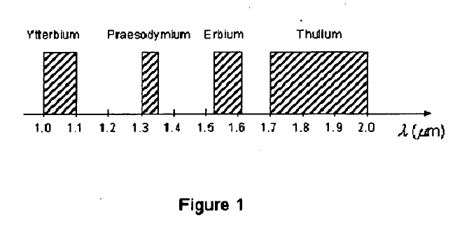

FIG. 2. Typical input and output spectra of an OPA-based wavelength converter.

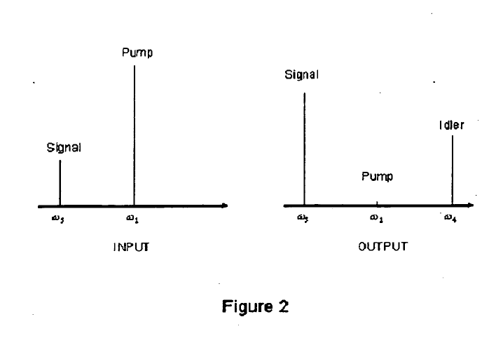

FIG. 3. Plot of the wavevector mismatch Db vs u, showing the various shapes of the parabolas obtained by varying beta₂. The horizontal lines represent different values of the parameter Db_{NL}. The intersections of the horizontal lines with the parabolas give the values of u where maximum pump depletion can be obtained.

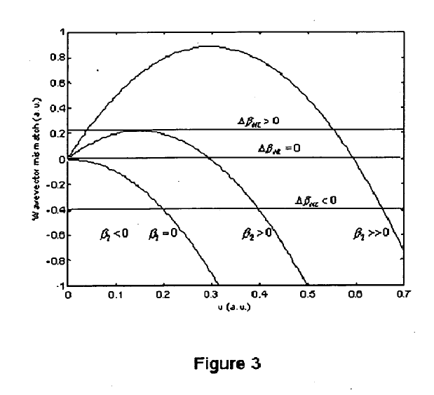

FIG. 4. Plots of P₄ vs lambda₄, for different values of P₃₀ (written next to the curves, in Watts). The other parameters are: P₁₀=3 W; L=80 m; lambda₀=1612 nm; lambda₁=1611.8 nm;

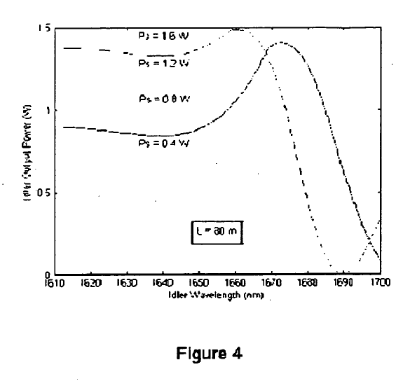

beta₄=−1*10⁻⁵⁵ s⁴/m; Dlambda=0.024 ps nm⁻² km⁻¹; g=12 W⁻¹ km⁻¹.

FIG. 5. Same as FIG. 4, except for L=40 m.

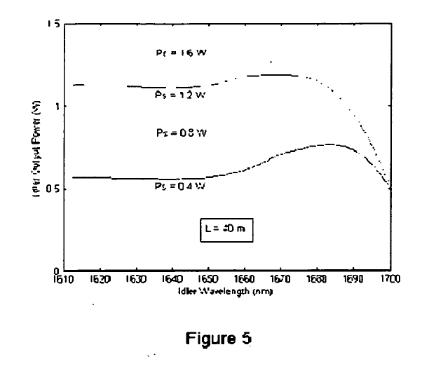

FIG. 6. Plots of P₄ vs lambda₄, for different values of lambda₁ (written next to the curves, in nanometers). The other parameters are: P₁₀=3 W; P₃₀=1.8 W; L=80 m; lambda₀=1612 nm; beta₄=−1*10⁻⁵⁵ s⁴/m; Dlambda=0.024 ps nm⁻² km⁻¹; g=12 W⁻¹ km⁻¹.

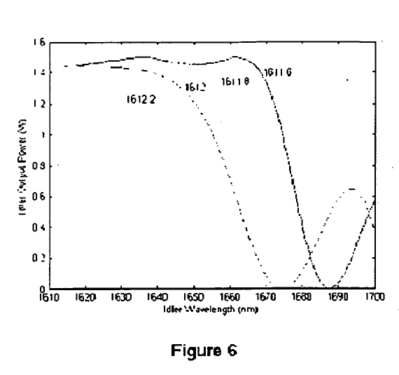

FIG. 7. Plots of optical conversion efficiency vs fiber length, for various signal input powers.

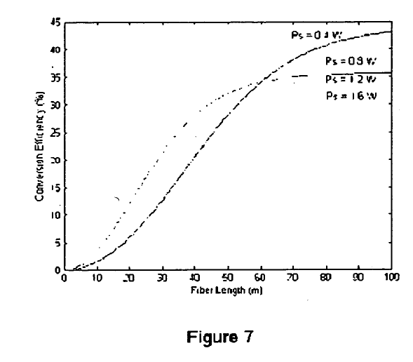

FIG. 8. Plots of optical conversion efficiency vs signal input power, for various fiber lengths.

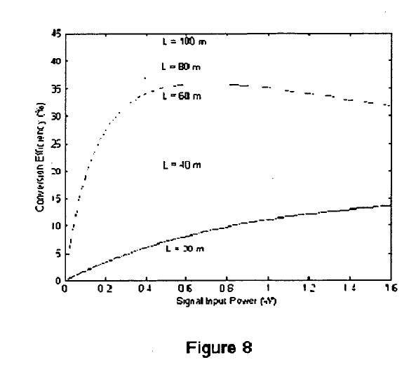

FIG. 9. Idler output wavelength as a function of signal wavelength two different pump wavelengths (1530 and 1620 nm).

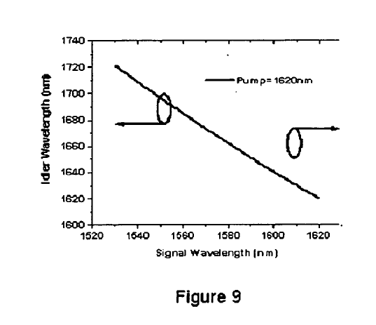

FIG. 10. (Left) Experimental setup. VCO=voltage-controlled oscillator; DFB=distributed-feedback laser; TBF=tunable bandpass filter; WDM=wavelength division multiplexing; OSA=optical spectrum analyzer. (Right) Typical OPA output optical spectrum displayed on the OSA.

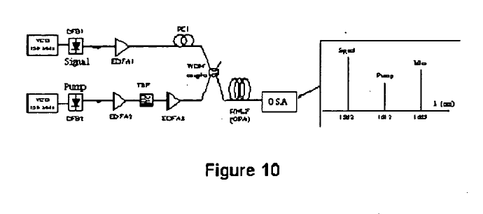

FIG. 11. Idler output power as a function of pump input power for 0.82 W of signal input power. Idler wavelength was approximately 1665 nm. The pump wavelength was optimized near 1612 nm to maximize idler output power.

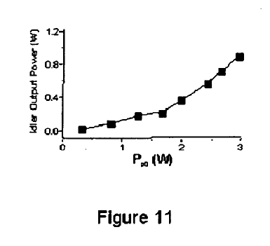

FIG. 12. Typical optical output spectrum displayed on the OSA; the peaks labeled FWM result from four-wave mixing among the three main waves.

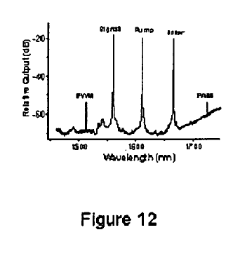

What is claimed is:

1. A fiber optical parametric wavelength converter comprising
a pump source,
a signal source with power exceeding one-fourth of the pump power,
means for combining pump and signal,
means for suppressing stimulated Brillouin scattering,
a nonlinear fiber,
whereby idler output power in excess of 0.1 watt is obtained, varying by less than 1 decibel over more than 30 nanometers, and with an optical conversion efficiency in excess of 20%.

2. The invention of claim 1, wherein said signal source and said pump source each emit a tunable single wavelength, thereby generating a tunable single wavelength idler.

3. The invention of claim 1, wherein said signal source emits at multiple wavelengths, and said pump source emits at a single wavelength, thereby generating a multiple-wavelength idler.

4. The invention of claim 1, wherein said signal source emits a broadband amplified spontaneous emission spectrum, and said pump source emits at a single wavelength, thereby generating a broadband idler.

5. The invention of claim 1, wherein said pump and signal sources are continuous-wave.

6. The invention of claim 5, with an idler output with a full-width at half maximum spectral width of less than 0.1 nm.

7. The invention of claim 1, wherein at least one of the said pump and signal sources is modulated by substantially rectangular pulses.

8. The invention of claim 1, wherein said pump and signal sources are amplified by fiber amplifiers.

9. The invention of claim 1, wherein said pump and signal sources are amplified by waveguide amplifiers.

10. The invention of claim 1, wherein said signal source emits in the C-band or in the L-band, and said pump source emits in the L-band, whereby the idler is in the 1620-1700 nm range.

11. The invention of claim 1, wherein said signal source emits in the C-band or in the L-band, and said pump source emits in the C-band, whereby the idler is in the 1450-1530 nm range.

12. The invention of claim 1, wherein said signal source has a wavelength in the gain region of a rare-earth doped fiber, and said pump source has a wavelength in the gain region of the same type of rare-earth doped fiber, whereby an idler with a wavelength outside the gain region of the rare-earth doped fiber is generated.

13. The invention of claim 1, wherein said signal source has a wavelength in the gain region of a rare-earth doped fiber, and said pump source has a wavelength in the gain region of a different type of rare-earth doped fiber, whereby an idler with a wavelength outside the gain region of either type of rare-earth doped fiber is generated.

14. The invention of claim 1, wherein said pump-signal combiner is a dielectric thin-film beamsplitter.

15. The invention of claim 1, wherein said pump-signal combiner is a fused-fiber coupler.

16. The invention of claim 1, comprising a wavelength de-multiplexer to separate signal, pump and idler wavelengths at the output.

17. The invention of claim 1, wherein said stimulated Brillouin scattering suppression is obtained by direct modulation of the currents of semiconductor pump and signal laser sources.

18. The invention of claim 1, wherein said stimulated Brillouin scattering suppression is obtained by external phase modulation of the pump and signal laser sources.

19. The invention of claim 1, comprising polarization-maintaining fibers.

20. The invention of claim 1, wherein said nonlinear fiber is replaced by a nonlinear waveguide.
